(19) United States
(12) Patent Application Publication
(10) Pub. No.: US 2016/0169197 A1
(43) Pub. Date: Jun. 16, 2016

(54) WIND TURBINE

(71) Applicant: EH NEW FOREST LIMITED, Aberdeenshire (GB)

(72) Inventor: Eagene Mak, Aberdeen (GB)

(21) Appl. No.: 14/904,518

(22) PCT Filed: Jul. 10, 2014
(86) PCT No.: PCT/GB2014/052115

§ 371 Date: Jan. 12, 2016

(30) Foreign Application Priority Data
Jul. 12, 2013 (GB) 1312517.4

(51) Int. Cl. F03D 3/06; F03D 9/00; F03D 3/00

(52) U.S. Cl. CPC F03D 3/061; F03D 3/005; F03D 3/065; F03D 9/002

(57) ABSTRACT

A turbine having a first set of at least three aerofoil shaped blades, a second set of at least three aerofoil shaped blades, and a substantially flat plate having an upper and a lower surface, the first set of at least three aerofoil shaped blades attached to the upper surface of the substantially flat plate and the second set of at least three aerofoil shaped blades attached to the lower surface of the substantially flat plate. The first set of at least three aerofoil shaped blades are vertically spaced and offset from the second set of at least three aerofoil shaped blades. The solidity of the turbine is from 0.5 to 5.

The present invention relates to a turbine and in particular a vertical axis wind turbine.

Vertical Axis Wind Turbines (VAWT's) are becoming a popular alternative to the more widely used and seen Horizontal Axis Wind Turbines (HAWT's). VAWT's do not require alignment with the direction of the wind and can better harness the power of non-laminar or turbulent air flow.

The advantages of VAWT's over the more conventional HAWT's designs make them particularly suited to installation in urban environments. VAWT's are also a good solution where space is at a premium.

VAWT's have been the subject of much research and development in recent years but there remain a number of key problems that must be addressed if VAWT's are going to provide a commercial solution to the ever growing demand for clean, renewable sources of electricity.

In accordance with a first aspect of the present invention there is provided a turbine comprising:
a first set of at least three aerofoil shaped blades; and
a second set of at least three aerofoil shaped blades;
   wherein the first set of at least three aerofoil shaped blades are vertically spaced and offset from the second set of at least three aerofoil shaped blades.

The turbine typically further comprises a substantially flat plate having an upper and a lower surface. The first set of at least three aerofoil shaped blades are normally attached to the upper surface of the substantially flat plate. The second set of at least three aerofoil shaped blades are normally attached to the lower surface of the substantially flat plate.

The first and second set of at least three aerofoil shaped blades may have a radially outwardly projecting portion at one or both ends. The radially outwardly projecting portion may be referred to as a winglet.

The turbine is typically a vertical axis wind turbine. The turbine may be referred to as a lift-based or lift-type turbine. The substantially flat plate and first and second sets of at least three aerofoil shaped blades may be arranged about a vertical axis.

The turbine may further include a second substantially flat plate having an upper and a lower surface, the first set of at least three aerofoil shaped blades attached to the lower surface of the second substantially flat plate. The turbine may further include a third substantially flat plate having an upper and a lower surface, the second set of at least three aerofoil shaped blades attached to the upper surface of the third substantially flat plate.

The turbine may therefore comprise at least three substantially flat plates arranged about a vertical axis, the first and second set of at least three aerofoil shaped blades arranged therebetween.

The spacing between the at least three substantially flat plates is typically even. The height of each blade of the first and second set of at least three aerofoil shaped blades is typically the same.

A set of at least three aerofoil shaped blades and two substantially flat plates may collectively be referred to as a tier. Normally the turbine comprises two tiers, optionally three tiers and may be four or more tiers. A turbine with more than one tier is typically referred to as a multi-tiered system.

The turbine may be used on land and/or on water. Where the turbine is used on land, the turbine may comprise at least two tiers. Where the turbine is used on water, the turbine may comprise at least four tiers. Where the turbine is located on water, the turbine may be attached to a buoy.

The substantially flat plates may be substantially circular. The substantially flat plates of each tier may have a different diameter. The substantially flat plates of each tier may have a different diameter such that the turbine is triangular-shaped. The triangular shape of the turbine may provide the turbine with better aerodynamics, particularly in stronger wind. The triangular configuration may alternatively or additionally lower the centre of gravity of the turbine by moving the bulk of the mass of the turbine from the top to the bottom.

When the turbine comprises three tiers a substantially flat plate at the top of an uppermost tier typically has a smaller diameter than a substantially flat plate at the top of a middle tier and the substantially flat plate at the top of the middle tier typically has a smaller diameter than a substantially flat plate at the top of a lowermost tier. In use the tiers may rotate in different directions. The uppermost and middle tiers may rotate in a first direction and the lowermost tier may rotate in a second direction.

The rotational direction of each tier is typically such that a rotational moment in the first direction is at least substantially the same as a rotational moment in the second direction.

It may be an advantage of the present invention that in use when the turbine is used on water, two or more tiers are counter-rotatable. The counter-rotation of two or more tiers of the turbine typically help balance the rotational moments of the turbine and this is therefore particularly helpful when the turbine is mounted on an unstable surface such as a buoy in water.

One or more of the substantially flat plates may be attached to a shaft. The shaft may pass through the centre of the one or more substantially flat plates. Each tier of the turbine may be attached to the same shaft, wherein the shaft extends through the centre of each tier. Each tier of the turbine may be attached to a different shaft. When the turbine comprises three tiers, the uppermost and the middle tiers rotatable in a first direction may be attached to a first shaft and the lowermost tier rotatable in a second direction may be attached to a second shaft. The first shaft may have a hollow centre. At least a portion of the second shaft may be at located within the hollow centre of the first shaft.

The aerofoil blades of the first set of at least three aerofoil shaped blades may be staggered from the aerofoil blades of the second set of at least three aerofoil shaped blades. That is the at least three aerofoil shaped blades of the first set may be in between the at least three aerofoil shaped blades of the second set when viewed from above.

Vertical wind turbines that use aerofoil shaped blades are known but wind contacting the surfaces of stationary aerofoil shaped blades does not generate any torque on the stationary wind turbine. A mechanical input is the only way to start the rotation of such existing vertical axis wind turbines.

The inventor of the present invention has realised that the ability of a turbine and in particular a vertical axis wind turbine to self-start, that is the ability of wind acting on the blades to start to move the blades and therefore also the rest of the turbine from stationary would be a significant advantage over other known turbines.

The vertically spaced and offset first and second set of at least three aerofoil shaped blades typically provide the turbine with the ability to self-start. As described above the vertically spaced and offset first and second set of at least three aerofoil shaped blades may also be described as two tiers of staggered aerofoil shaped blades.

Each blade of the first and second set of at least three aerofoil shaped blades typically has a leading edge and a trailing edge. An imaginary straight line joining the leading and trailing edges of each blade is referred to as a chord. Each blade of the first and second set of at least three aerofoil shaped blades also has a maximum thickness at any given position along the chord.

An outer edge of each aerofoil shaped blade is typically substantially parallel to an outer edge of the substantially flat plate.

An angle between the chord of a or each blade of the first and/or second set of at least three aerofoil shaped blades and a tangent to a circle defined by the rotation of the first and/or second set of at least three aerofoil shaped blades about the vertical axis, may be from 0 to 20°, preferably from 0 to 15°.

The substantially flat plate may be substantially circular. The diameter of the substantially circular and flat plate may be from 0.5 to 10 times, optionally from 2 to 6 times the length of the chord of the blades of the first and second set of at least three aerofoil shaped blades. The substantially flat plate may have a thickness of from 0.1 to 1 times, preferably from 0.1 to 0.5 times the maximum thickness of the blades at any given position along the chord of the first and second set of at least three aerofoil shaped blades.

Each blade of the first and second set of at least three aerofoil shaped blades is typically symmetrical. In use the blades rotate so unlike a similar shaped blade or wing on for example an aircraft, the leeward side of a blade becomes the windward side when the substantially flat plate that the blade is attached to has rotated 180°.

Each blade of the first and second set of at least three aerofoil shaped blades has a useful angle of attack. The useful angle of attack is defined by the angle between the chord and the direction of the relative wind. The useful angle of attack may be from −15 to +15°.

The useful angle of attack of a symmetrical aerofoil shaped blade may be greater than and may be twice that of an asymmetrical aerofoil shaped blade because when the leeward side of a blade becomes the windward side, the wind can act against the now windward side of the blade.

Each blade of the first and second sets of at least three aerofoil shaped blades is substantially straight. An end of each blade of the first and second set of at least three aerofoil shaped blades may be attached to the substantially flat plate. An end of each blade of the first and second set of at least three aerofoil shaped blades is typically attached at right angles to the substantially flat plate.

Known examples of VAWT's often suffer from destructive pulsations of torque as the wind contacts each blade as it moves into the area of the useful angle of attack. In use, the offset arrangement of the first and second set of at least three aerofoil shaped blades of the turbine according to the present invention smoothes out these pulsations.

The distance, also referred to as the linear distance, between the leading edge of one blade and the trailing edge of an adjacent blade of the first or second set of at least three aerofoil shaped blades may be from 0.5 to 4 times, preferably 0.5 to 2 times the length of the chord of the blades of the first and second set of at least three aerofoil shaped blades.

Each blade of the first and second set of at least three aerofoil shaped blades may be a symmetrical 4-digit NACA (National Advisory Committee for Aeronautics) aerofoil. Each blade of the first and second set of at least three aerofoil shaped blades may be of the type NACA 00XX where XX can be any number from 10 to 30. Each blade of the first and second set of at least three aerofoil shaped blades may in particular be of the type NACA 0018 or NACA 0020. Each blade of the first and second set of at least three aerofoil shaped blades may be of the type NACA 0016, NACA 0017 or NACA 0019.

The numbers from 10 to 30, of for example NACA 0010, describe the percentage of maximum thickness to chord length of the blade.

The leading edge of each blade of the first and/or second set of at least three aerofoil shaped blades normally faces the trailing edge of an adjacent blade of the first and/or second set of at least three aerofoil shaped blades respectively.

The substantially flat plate may be mounted on a shaft. The shaft may pass through the centre of the substantially flat plate. The substantially flat plate may be rotatable about the shaft. The shaft may be attached to or be part of an electric generator. The electric generator typically converts mechanical energy into electrical energy.

The turbine according to the first aspect of the present invention is particularly suited to generating electricity from non-laminar and/or turbulent air flow because wind from any direction contacting the first and second set of at least three aerofoil shaped blades results in rotational movement of the turbine.

The first set of at least three aerofoil shaped blades may be attached to the upper surface of the substantially flat plate and/or the second set of at least three aerofoil shaped blades may be attached to the lower surface of the substantially flat plate, such that the blades are attached to the plate at a distance of at least half the maximum thickness of the blade and preferably equal to or greater than the maximum thickness of the blade away from an outer edge of the plate. This provides for a portion of substantially flat plate between the blade and the outer edge of the plate.

It is an advantage of the present invention that in use, the portion of substantially flat plate between the blade and the outer edge of the plate improves the efficiency of the blades of the first and second set of at least three aerofoil shaped blades and/or helps to recover some of the blade tip vortex energy that would otherwise be lost.

The portion of substantially flat plate between the blade and the outer edge of the plate may improve the flow of air at the end of the blade attached to the substantially flat portion. The portion of substantially flat plate between the blade and the outer edge of the plate may increase the lift generated by each blade and/or reduce the drag caused by slippage of air at the end of each blade attached to the substantially flat portion.

The flow of air at the end of each blade may be referred to as lift-induced drag or air stream slippage.

In accordance with a second aspect of the present invention there is provided a turbine comprising at least three aerofoil shaped blades arranged about a central axis, wherein the solidity of the turbine is from 0.5 to 5.

The at least three aerofoil shaped blades may have the same shape and/or dimensions and/or size.

The solidity of the turbine may be expressed as the sum of the number of blades multiplied by the chord length of one of the at least three aerofoil shaped blades, divided by the distance between the chord of one of the blades of the at least three aerofoil shaped blades and a centre point of the central axis.

The central axis may in use be a central vertical axis.

The inventor of the present invention has realised that the solidity of a turbine and in particular a vertical axis wind turbine is particularly important when trying to optimise the performance of the turbine. Conventional designs try to minimise solidity in favour of less dense and therefore lighter designs that present a smaller moment of inertia. It is an advantage that the turbine according to the second aspect of the present invention has a relatively high solidity and therefore high moment of inertia.

The solidity of the turbine may be from 2 to 4, normally from 2.5 to 3.5. The solidity of the turbine may be from 0.5 to 2. The solidity of the turbine may be from 1 to 2. The solidity of the turbine may typically be around 1.5.

The optional features of the second aspect of the present invention can be incorporated into the first and third aspects of the present invention and vice versa.

In accordance with a third aspect of the present invention there is provided a turbine comprising:
at least three aerofoil shaped blades;
a first substantially flat plate; and
a second substantially flat plate
   wherein the at least three aerofoil shaped blades are arranged between the first and the second substantially flat plates.

The first and second substantially flat plates may each have an upper and a lower surface. The at least three aerofoil shaped blades are normally attached to the lower surface of the first substantially flat plate and the upper surface of the second substantially flat plate.

The turbine is typically a vertical axis wind turbine. The turbine may be referred to as a lift-based or lift-type turbine. The first and second substantially flat plates and at least three aerofoil shaped blades may be arranged about a central axis.

The optional features of the third aspect of the present invention can be incorporated into the first and second aspects of the present invention and vice versa.

An embodiment of the invention will now be described by way of example only and with reference to the accompanying drawings, in which:

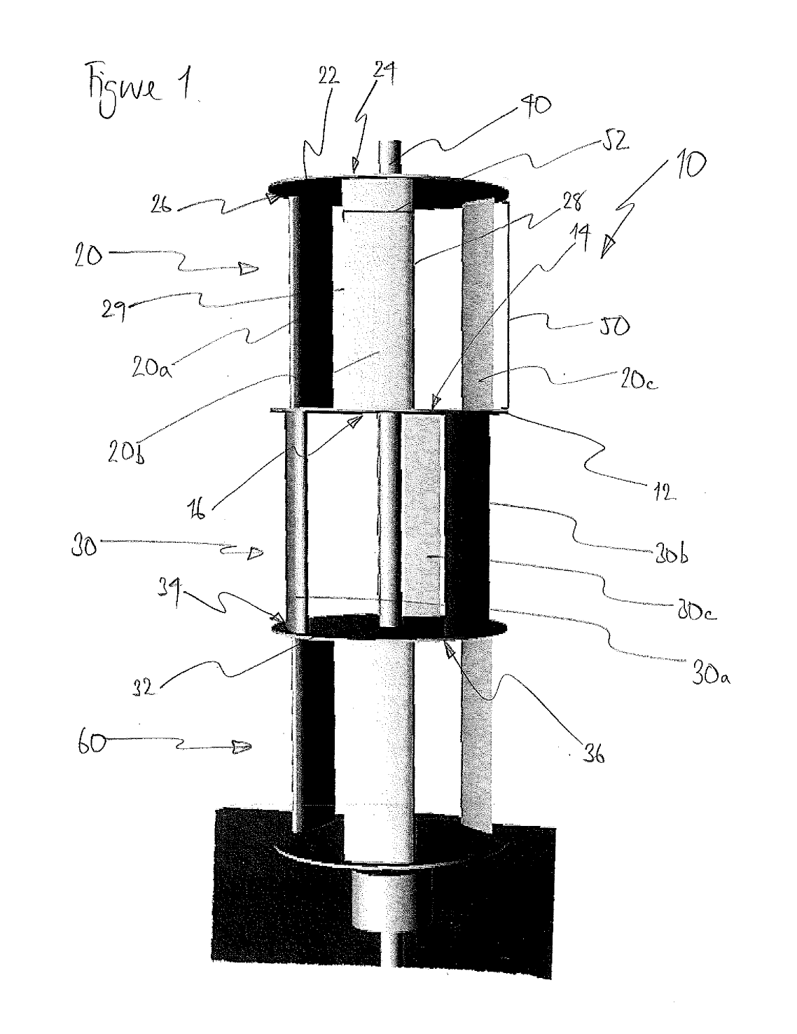

FIG. 1 is a perspective view of the turbine according to an embodiment of the present invention;

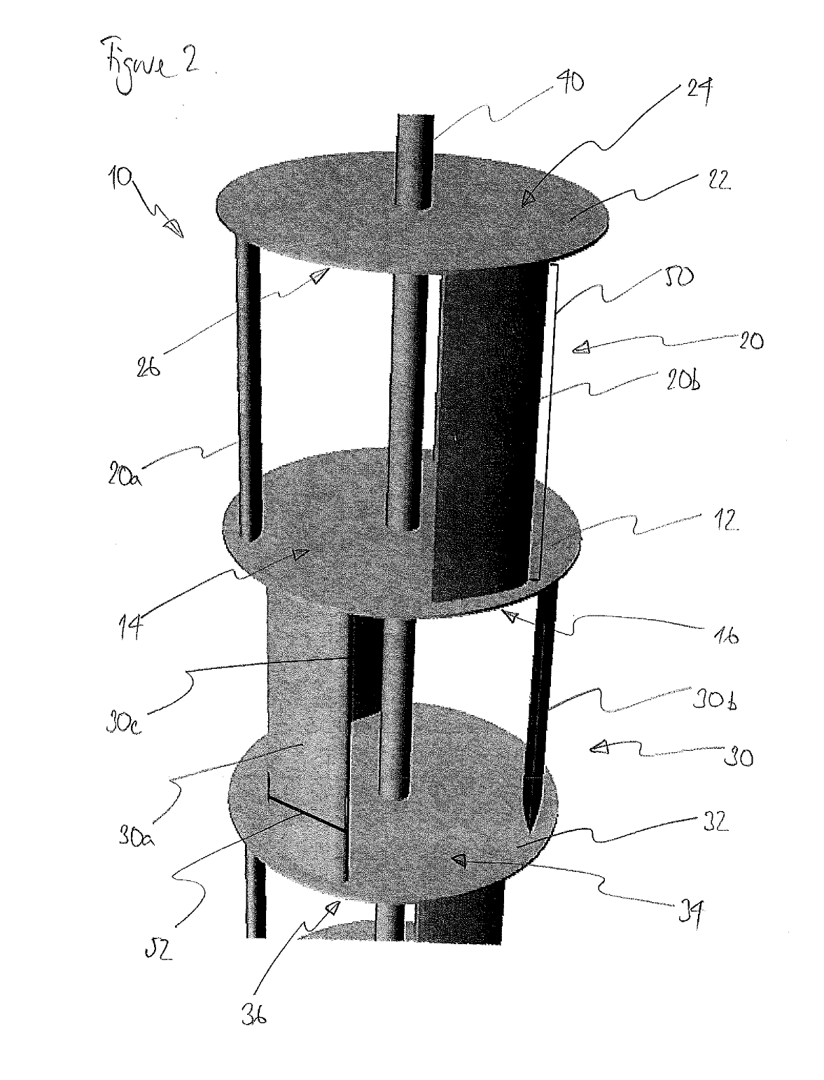

FIG. 2 is an exploded perspective view of a portion of the same turbine;

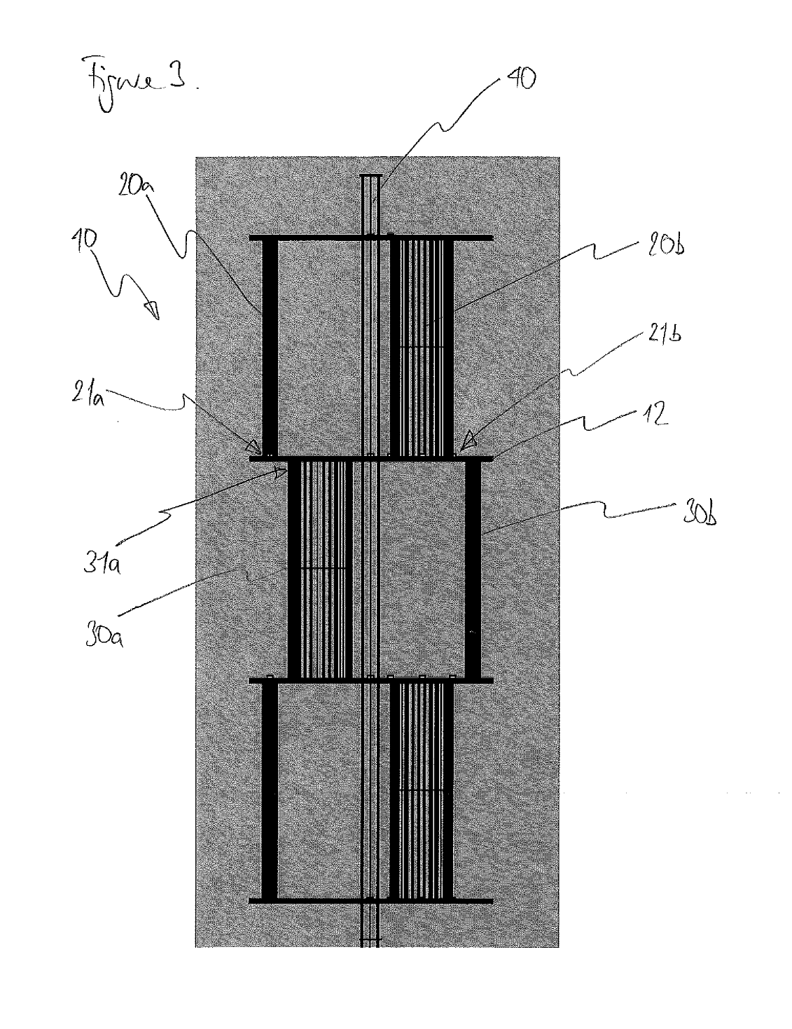

FIG. 3 is a vertical cross-sectional view of the turbine;

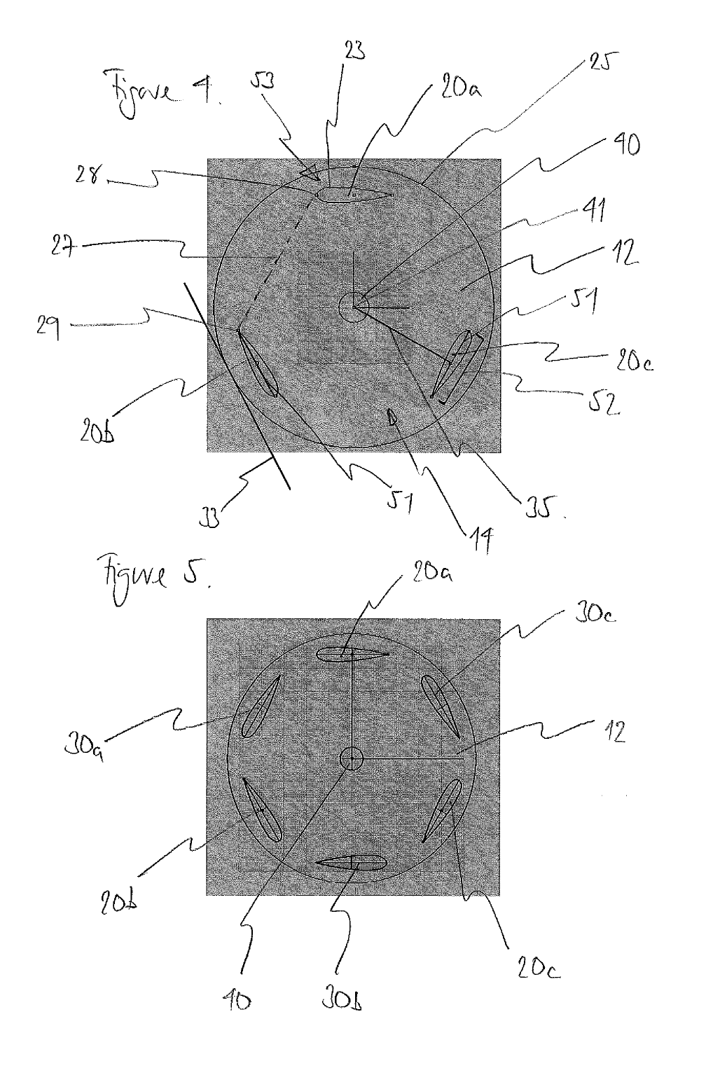

FIG. 4 is a plan view of the top of the turbine;

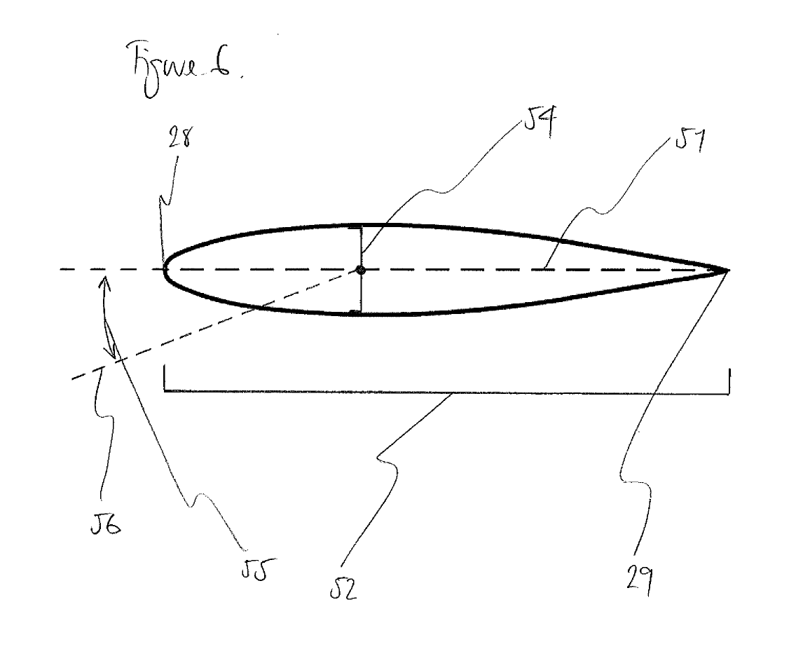

FIG. 5 is a horizontal cross-sectional view of the turbine;

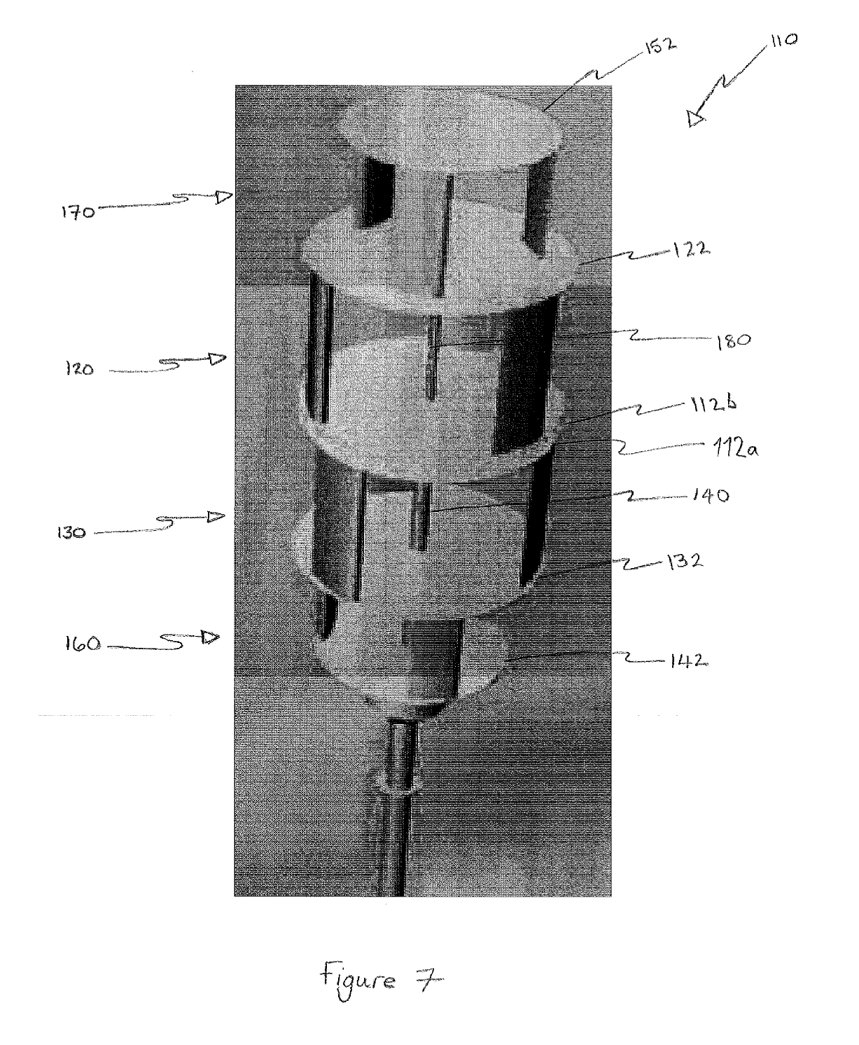

FIG. 6 is a cross-sectional view of a blade according to an embodiment of the present invention; and

FIG. 7 is a perspective view of the turbine according to a further embodiment of the present invention.

FIG. 1 shows a turbine 10. The turbine 10 has a flat plate 12 having an upper 14 and a lower 16 surface. A first set 20 of three aerofoil shaped blades are attached to the upper surface 14 of the flat plate 12. A second set 30 of three aerofoil shaped blades are attached to the lower surface 16 of the flat plate 12. The first set 20 of three aerofoil shaped blades are vertically spaced and offset from the second set 30 of three aerofoil shaped blades.

The first set 20 of three aerofoil shaped blades comprise blades 20a, 20b and 20c. The second set 30 of three aerofoil shaped blades comprise blades 30a, 30b and 30c.

The turbine 10 is a vertical axis wind turbine. The flat plate 12 and first 20 and second 30 sets of three aerofoil shaped blades are mounted on a shaft 40 and are thereby arranged about a vertical axis. The shaft 40 passes through the centre of the flat plate 12. In use, rotation of the first 20 and second 30 sets of blades and the flat plate 12 causes rotation of the shaft 40.

The turbine 10 includes a second flat plate 22 having an upper 24 and a lower 26 surface, the first set 20 of three aerofoil shaped blades attached to the lower 26 surface of the second flat plate 22. The turbine 10 further includes a third flat plate 32 having an upper 34 and a lower 36 surface, the second set 30 of three aerofoil shaped blades attached to the upper 34 surface of the third flat plate 32.

The turbine 10 comprises three flat plates 12, 22, 32 arranged about a vertical axis and attached to the shaft 40, the first 20 and second 30 set of three aerofoil shaped blades arranged therebetween.

The spacing between the three flat plates 12, 22, 32 is even. The height 50 of each blade of the first 20 and second 30 sets of three aerofoil shaped blades is the same. The chord length 52 of each blade of the first 20 and second 30 sets of three aerofoil shaped blades is also the same.

A leading edge 28 of each blade of the first 20 and second 30 set of three aerofoil shaped blades faces a trailing edge 29 of an adjacent blade of the first 20 and/or second 30 set of three aerofoil shaped blades respectively.

Each blade 20a-c and 30a-c of the first 20 and second 30 set of three aerofoil shaped blades has a symmetrical cross-section. The turbine 10 had a third set 60 of three aerofoil shaped blades.

The flat plates 12, 22, 32 are typically solid from their outer edge to their centre at the shaft 40. It may be an advantage of the present invention that the flat plates 12, 22, 32 are solid so that in use air in the turbine is channeled towards the blades rather than through the flat plates and/or turbine. The efficiency of the turbine may be increased by up to 50% when the plates are solid.

FIG. 2 shows an exploded perspective view of a portion of the same turbine 10. FIG. 3 shows a vertical cross-sectional view of the turbine 10. The common features of the turbine 10 shown in FIGS. 1, 2 and 3 have been labelled with the same reference numbers.

Each blade of the first 20 and second 30 sets of three aerofoil shaped blades is straight. An end of each blade, for example 21a, 21b and 31a of the first 20 and second 30 set of three aerofoil shaped blades is attached to the flat plate 12. The blades 20a-c and 30a-c of the first 20 and second 30 set of three aerofoil shaped blades are attached at right angles to the flat plate 12.

The flat plate 12 is 0.5 times the maximum thickness of the blade 20a.

In use, wind contacts the surfaces of the blades 20a-c and 30a-c to turn the shaft 40 of the turbine 10. The shaft 40 is attached to an electric generator (not shown) to convert mechanical energy into electrical energy.

In use, the blades 20a-c and 30a-c rotate around the central axis so the leeward side of the blades becomes the windward side when the flat plate 12 that the blades are attached to has rotated 180°. The offset arrangement of the first 20 and second 30 set of three aerofoil shaped blades 20a-c and 30a-c of the turbine 10 smoothes out pulsations that would occur when the wind is in the useful angle of attack of each blade (see FIG. 6).

FIG. 4 shows a plan view of the top of the turbine 10. The flat plate 12 is circular. The diameter of the circular flat plate 12 is 3.5 times the chord length 52 of the blades 20a-c.

An outer edge of each blade, for example outer edge 23 of blade 20a, is substantially parallel to an outer edge 25 of the flat plate 12.

An angle between the chord 51 of the blade 20b and a tangent 33 to a circle 25 defined by the rotation of the first set of three aerofoil shaped blades 20a-c about a vertical axis, in this case the shaft 40, is 0°. The line labelled 25 in FIG. 4 is the outer edge of the flat plate 12 and also the circle defined by rotation of the first set of three aerofoil shaped blades 20a-c about the shaft 40.

The first set 20 of three blades 20a-c is attached to the upper surface 14 of the flat plate 12, such that there is a distance or gap 53, with a width equal to the maximum thickness (see FIG. 6) of the blades 20a-c, between the outer edges of the blades, for example outer edge 23 of blade 20a, and the outer edge 25 of the flat plate 12.

The distance 27 between the leading edge 28 of one blade 20a and the trailing edge 29 of an adjacent blade 20b is two times the chord length (see FIG. 6) of the blades 20a and 20b.

In use, the gap 53 improves the efficiency of the blade 20a by helping to recover some of the blade tip vortex energy (not shown) that would otherwise be lost from the end of the blade 20a.

The gap 53 increases the laminar and reduces the turbulent flow of air at the end of the blade 20a. The gap 53 increases the lift generated and reduces the drag caused by turbulent flow of air at the end of the blade 20a. The gap 53 may increase the efficiency of the turbine by up to 10%.

The turbine 10 has a relatively high solidity.

The solidity of the turbine 10 is 2.7. The solidity of the turbine 10 is the sum of the number of blades 20a-c multiplied by the chord length 52 of the blade 20c, divided by the distance 35 between the chord 51 of the blade 20c and a centre point 41 of the central axis or shaft 40.

FIG. 5 shows a horizontal cross-sectional view of the turbine 10. The blades 20a-c of the first set 20 are staggered from the blades 30a-c of the second set 30. The blades 20a-c of the first set 20 are in between the blades 30a-c of the second set 30 when viewed from above.

FIG. 6 shows a cross-sectional view of a blade 20a. All blades 20a-c and 30a-c are the same shape and design.

The blade 20a has a leading edge 28 and a trailing edge 29. A straight line 51 joining the leading 28 and trailing 29 edges of the blade 20a is referred to as the chord. The blade 20a also has a maximum thickness 54 at a given position along the chord 51.

The blade 20a has an useful angle of attack 55. The useful angle of attack 55 is the angle between the chord 51 and the direction of the relative wind 56. The useful angle of attack 55 is 10°.

The blade 20a, and so also blades 20a-c and 30a-c, is a symmetrical 4-digit NACA (National Advisory Committee for Aeronautics) aerofoil of the type NACA 0018.

FIG. 7 shows an alternative embodiment of the turbine 110. The features of the turbine 110 in FIG. 7 are substantially the same as the features of the turbine 10 shown in FIG. 1 and are labelled with the same numbers prefixed with 1.

The turbine 110 is a vertical axis wind turbine attached to a buoy (not shown) on water. The turbine 110 has four tiers. A first set of three aerofoil shaped blades 160 and a flat plate 142 and a second flat plate 132 is a first tier. A second set of three aerofoil shaped blades 130 and a flat plate 132 and a second flat plate 112a is a second tier. A third set of three aerofoil shaped blades 120 and a flat plate 112b and a second flat plate 122 is a third tier. A fourth set of three aerofoil shaped blades 170 and a flat plate 122 and a second flat plate 152 is a fourth tier.

The flat plates 142, 132 and 112a of the first and second tiers are attached to a first shaft 140. The flat plates 112b, 122 and 152 of the third and fourth tiers are attached to a second shaft 180. The first shaft 140 has a hollow centre. A portion of the second shaft 180 is located within the hollow centre of the first shaft. The first and second tiers are attached to the first shaft 140 and in use rotate the first shaft. The third and fourth tiers are attached to the second shaft 180 and in use rotate the second shaft.

The uppermost 152 and lowermost 142 flat flat plates have a smaller diameter than the inner four flat plates 122, 112b, 112a and 132.

In use the first and second tiers rotate in a clockwise direction and the third and fourth tiers rotate in an anti-clockwise direction.

Modifications and improvements can be incorporated herein without departing from the scope of the invention.

1. A turbine comprising:
a first set of at least three aerofoil shaped blades;
a second set of at least three aerofoil shaped blades; and
a substantially flat plate having an upper and a lower surface, the first set of at least three aerofoil shaped blades attached to the upper surface of the substantially flat plate and the second set of at least three aerofoil shaped blades attached to the lower surface of the substantially flat plate;
wherein the first set of at least three aerofoil shaped blades are vertically spaced and offset from the second set of at least three aerofoil shaped blades; and
wherein the solidity of the turbine is from 0.5 to 5.

2. A turbine according to claim 1, wherein the at least three aerofoil shaped blades are the same shape and size.

3. A turbine according to claim 1, wherein the solidity of the turbine is from 1 to 2.

4. A turbine according to claim 1, wherein each blade of the at least three aerofoil shaped blades has a leading edge and a trailing edge and a chord defined by a line joining the leading and trailing edges, the distance between the leading edge of one blade and the trailing edge of an adjacent blade is from 0.5 to 4 times the length of the chord of the blades of the at least three aerofoil shaped blades.

5. A turbine according to claim 1, wherein the first set of at least three aerofoil shaped blades is attached to the upper surface of the substantially flat plate and the second set of at least three aerofoil shaped blades is attached to the lower surface of the substantially flat plate, such that the blades are attached to the plate, at a distance of at least half the maximum thickness of the blades, away from an outer edge of the plate.

6. A turbine according to claim 1, the first and second set of at least three aerofoil shaped blades having a radially outwardly projecting portion at one end.

7. A turbine according to claim 1, wherein the turbine is a vertical axis wind turbine.

8. A turbine according to claim 1, wherein the substantially flat plate and first and second sets of at least three aerofoil shaped blades are arranged about a vertical axis.

9. A turbine according to claim 1, the turbine further comprising a second substantially flat plate having an upper and a lower surface, the first set of at least three aerofoil shaped blades attached to the lower surface of the second substantially flat plate.

10. A turbine according to claim 1, the turbine further comprising a third substantially flat plate having an upper and a lower surface, the second set of at least three aerofoil shaped blades attached to the upper surface of the third substantially flat plate.

11. A turbine according to any of claim 1, wherein an outer edge of each aerofoil shaped blade is substantially parallel to an outer edge of the substantially flat plate.

12. A turbine according to claim 1, wherein each blade of the first and second set of at least three aerofoil shaped blades is symmetrical in at least one dimension.

13. A turbine according to claim 1, wherein an end of each blade of the first and second set of at least three aerofoil shaped blades is attached at right angles to the substantially flat plate.

14. A turbine according to claim 1, wherein a leading edge of each blade of the first and second set of at least three aerofoil shaped blades faces a trailing edge of an adjacent blade of the first and second set of at least three aerofoil shaped blades respectively.

15. A turbine according to claim 1, wherein each blade of the first and second set of at least three aerofoil shaped blades is one of a symmetrical NACA 0016, NACA 0017, NACA 00113, NACA 0019 or NACA 0020 type aerofoil.

16. A turbine according to claim 1, wherein the substantially flat plate is attached to a shaft, the shaft passing through the centre of the substantially flat plate.

17. A turbine according to claim 1, wherein the shaft is operably connected to an electric generator.

18. A turbine comprising: at least three aerofoil shaped blades; a first substantially flat plate; and a second substantially flat plate wherein the least three aerofoil shaped blades are arranged between the first and the second substantially flat plates.

19. A turbine according to claim 1, wherein the first and second substantially flat plates each have an upper and a lower surface, the at least three aerofoil shaped blades being attached to the lower surface of the first substantially flat plate and the upper surface of the second substantially flat plate.

20. A turbine according to claim 1, wherein the turbine is a vertical axis wind turbine, the first and second substantially flat plates and at least three aerofoil shaped blades arranged about a central axis.
